(19) United States
(12) Patent Application Publication
(10) Pub. No.: US 2006/0044451 A1
(43) Pub. Date: Mar. 2, 2006

(54) Wide angle lenslet camera

(75) Inventors: Rongguang Liang, Penfield, NY (US); David Kessler, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/929,873

(22) Filed: Aug. 30, 2004

(51) Int. Cl. H04N 5/225

(52) U.S. Cl. 348/340

(57) ABSTRACT

An imaging apparatus (40) has a sensor array (16) comprising a plurality of optical sensors (18) arranged in a convex curvature and a lenslet array (24) with a plurality of lenslets (22) similarly arranged in a convex curvature. At least one lenslet (22) in the lenslet array (24) directs light toward at least one optical sensor (18) in the sensor array (16).

### FIELD OF THE INVENTION

This invention generally relates to image capture devices and more particularly relates to a camera having a lenslet array and providing improved wide-angle image capture and improved image quality over conventional designs using lenslets.

### BACKGROUND OF THE INVENTION

The challenge of providing wide-angle image capture has conventionally been addressed using optical systems that require a relatively short back working distance with short focal length. These systems are characterized by bulky lens components, not easily packaged in compact form and not suitable for use in hand-held devices or other apparatus where small size is needed. The design of highly compact, wide-angle image capture optics proves to be challenging and typically requires some compromise in performance and significant effort to minimize image aberrations.

To date, lenslet arrays have been employed within optical systems for concentrating light from other optical components onto small-scale photodetector devices. Examples of typical uses and configurations of lenslet arrays include the following:
Commonly-assigned U.S. Pat. No. 6,137,535 (Meyers) discloses a compact digital camera using an array of custom-fabricated lenslets. In the embodiment described in the Meyers '535 disclosure, individual lenslets are fabricated in decentered form, to direct light from a different section of the field of view onto a planar photosensor. This type of design becomes highly complex, as each lenslet has a slightly different shape; moreover, as shown in the '535 disclosure, supporting light-guiding structures having varied angular inclinations are also needed.
European Application EP 1079 613 (Tanida et al.) discloses a compound imaging apparatus employing a lenslet array that is compact and provides improved resolution over earlier designs.
Japanese Patent Application No. JP 10-107975 (Satoshi) discloses a compound imaging apparatus employing a lenslet array and a corresponding sensor array, both having a concave shape for obtaining improved resolution and brightness.
U.S. Patent Application Publication No. 2002/0075450 (Aratani et al.) discloses a compound eye imaging system optimized for obtaining images with improved depth detection. In the apparatus of the '5450 Aratani et al. disclosure, individual lenslets may be shaped differently to redirect light from the imaged object.
European Patent No. EP 0 821 532 (Ono) discloses use of a compound eye imaging system for stereoscopic imaging applications.
U.S. Patent Application Publication No. 2003/0111593 (Mates) discloses a compound eye imaging system having a lenslet array, wherein the shape of individual lenslet structures is adapted to collect light from an object.
U.S. Patent Application Publication No. 2003/0086013 (Aratani) discloses an alternate design for a camera apparatus using a compound-eye lenslet array.
U.S. Pat. No. 4,783,141 (Baba et al.) discloses a curved array of lenses for use in a variable magnification compound-eye imaging system.

As this patent literature shows, lenslet arrays are advantaged in providing a refractive component with a thin profile and relatively low cost, usable in a number of types of imaging apparatus, including those requiring a large field of view. Lenslet arrays can be scaled to accommodate a widened field of view, simply by adding one or more rows or columns of lenslets to an array. However, conventional lenslet array arrangements exhibit a number of problems, including reduced numerical aperture (large f/#) relative to conventional optical solutions and large, overlapping image fields.

Compound-eye imaging is modeled upon the optical arrangement of the insect eye, in which an array of tiny individual eyes (ommatidia) cooperate to provide an image having a very wide field of vision. The compound-eye imaging model has also been used for reducing the working distance of light sensing and imaging systems. For example, the TOMBO (Thin Observation Module by Bound Optics) optoelectronic system described in an article entitled “Thin observation module by bound optics (TOMBO): concept and experimental verification” by Jun Tanida et al. in Applied Optics (Vol. 40, No. 11), Apr. 10, 2001, utilizes a microlens array to provide compound-eye imaging to capture high-resolution images in a compact imaging device. As noted in the Tanida et al. disclosure, however, compound-eye imaging using conventional techniques with a planar lens array is hampered by the reduced numerical aperture of individual lenses.

There is a recognized need for thin-profile imaging devices in a number of imaging markets, for devices such as cell phones, compact medical imaging devices, and other apparatus. While lenslet arrays provide some advantages such as compact sizing due to reduced working distance, the limitations of these devices with respect to numerical aperture and limited field of view constrain the use of these devices in hand-held imaging apparatus.

### SUMMARY OF THE INVENTION

It is an object of the present invention to provide an image capture device using a lenslet array and providing improved field of view. With this object in mind, the present invention provides an imaging apparatus comprising:
(a) a sensor array comprising a plurality of optical sensors arranged in a convex curvature; and
(b) a lenslet array comprising a plurality of lenslets similarly arranged in a convex curvature, wherein at least one lenslet in the lenslet array directs light toward at least one optical sensor in the sensor array.

It is a feature of the present invention that it provides an image capture system using compound eye imaging.

It is an advantage of the present invention that it provides a wide field of view with increased light collection efficiency in a compact apparatus.

It is a further advantage of the present invention that it provides increased numerical aperture over many flat-panel lenslet array designs.

It is a further advantage of the present invention that it is scalable and provides improved distortion and reduced vignetting over conventional, single-stage optical designs.

One optical design embodiment of the present invention using a doublet array arrangement is particularly advantaged for correcting chromatic aberration and for providing improved point spread function over conventional single-stage designs.

It is yet a further advantage of the present invention that it provides improved resolution over conventional planar lens array configurations.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a side view showing how an image is obtained using a conventional planar lens array;

FIG. 2 is a side view of the curved arrangement of lenslets and their corresponding sensors according to the present invention;

FIG. 3 is an enlarged view of the compound-eye imaging components of the present invention;

FIG. 4 is a block diagram showing image capture and processing components of a camera according to the present invention;

FIGS. 5A and 5B are side views showing doublet design for a lenslet according to alternate embodiments of the present invention;

FIG. 6 is a side view showing the lens array of the present invention with a color-separating component;

FIG. 7 is an enlarged view of a prism configured as a color-separating component;

FIG. 8A is a perspective view of a curved lenslet array with 78% fill factor according to the present invention;

FIG. 8B is an enlarged view of a portion of the curved lenslet array of FIG. 8A; and

FIG. 9 is a perspective view of a curved lenslet array with 100% fill factor according to the present invention.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

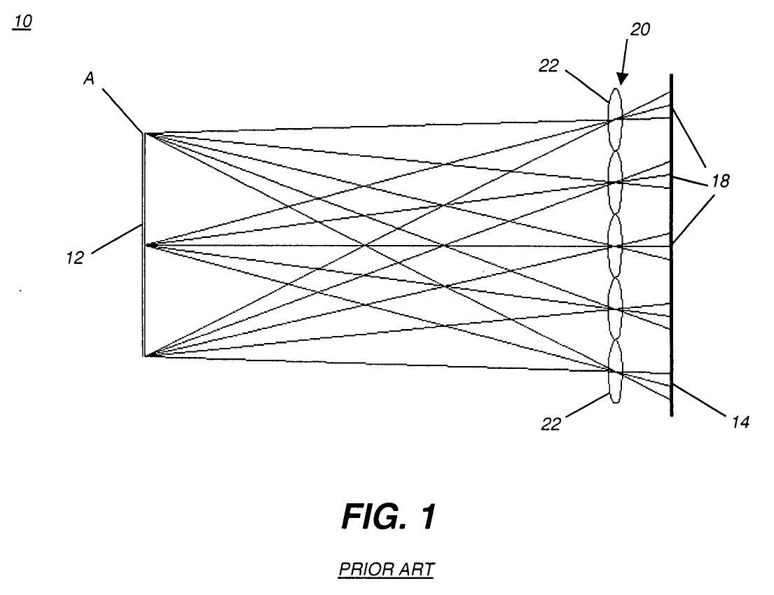

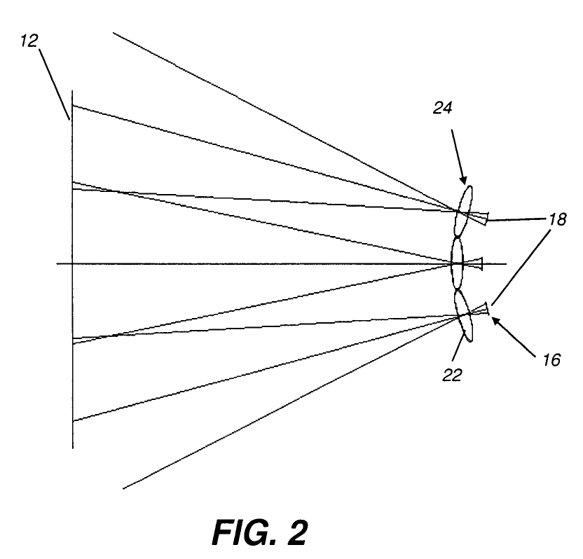

The inventive nature of the apparatus and method of the present invention is based on an adaptation of lenslet arrays and their corresponding sensor components, as can be seen in a comparison of FIGS. 1 and 2. In conventional use, as shown in FIG. 1, an image capture apparatus 10 employs a flat, planar lenslet array 20 for directing light from an object 12 to a sensor array 14. Sensor array 14 has an arrangement of sensors 18, such as CCD or CMOS sensors, for example. In a typical distribution, each lens 22 has a corresponding sensor 18; however, the assignment of one sensor 18 to multiple lenses 22 is also possible.

One difficulty with the planar arrangement of lenslet array 20 and its corresponding sensor array 14 in FIG. 1 relates to image quality inconsistencies across the field. Each lens 22 has a relatively large field, so that portions of images from different sensors are superimposed. This means that light from the same point source is detected at multiple sensors 18. Referring to FIG. 1, for example, light from point A on object 12 is directed to each sensor 18 in sensor array 14. The TOMBO imaging system, described in the background section above, compensates for this problem by modifying the sensed data that was obtained using image processing software; however, this type of solution can yield disappointing results for image resolution and overall image quality. The optical arrangement disclosed in U.S. Pat. No. 6,137,535 attempts to compensate somewhat for this overlap condition with a complex arrangement of matched, individually decentered lenslets and light guiding structures. Because of the inherent complexity of this solution, it would prove expensive to implement.

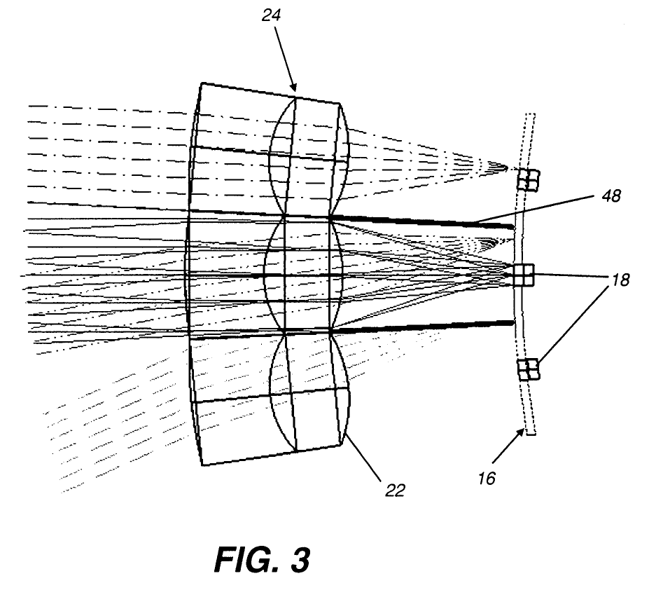

In contrast to the configuration of FIG. 1, the compound-eye imaging arrangement of FIG. 2 uses a curved lenslet array 24 having a number of lenses 22 for directing light to sensors 18 in a curved sensor array 16. Unlike the planar arrangement of FIG. 1, the curved shape used for curved lenslet array 24 effectively separates the field of view of each lens 22, allowing each lens 22 to collect light from a different part of the field. In contrast to the planar arrangement of FIG. 1, each lens 22 images a smaller field, which allows higher resolution and overall image quality. At the same time, each lens 22 can also have a lower f/#, allowing increased light collection. This can be particularly advantageous for compensation along fringe areas of each field, where there is slight overlap between fields for adjacent lenses 22. Referring to FIG. 3, there is shown a portion of curved lenslet array 24 and the corresponding portion of curved sensor array 16. Baffles 48 are provided for minimizing crosstalk between channels. It must be stressed that FIGS. 2 and 3 show cross-sectional side views only. Lenslet array 24 is a two dimensional matrix of lenses 22 distributed over a surface having a generally spherical shape. Sensors 18 in curved sensor array 16 can be standard components mounted onto a flexible substrate or can be fabricated directly onto a flexible substrate. For example, curved sensor array 18 can be formed onto a flexible substrate using organic semiconductors, as described in U.S. Patent Application Publication No. 2002/0017612 (Yu et al.)

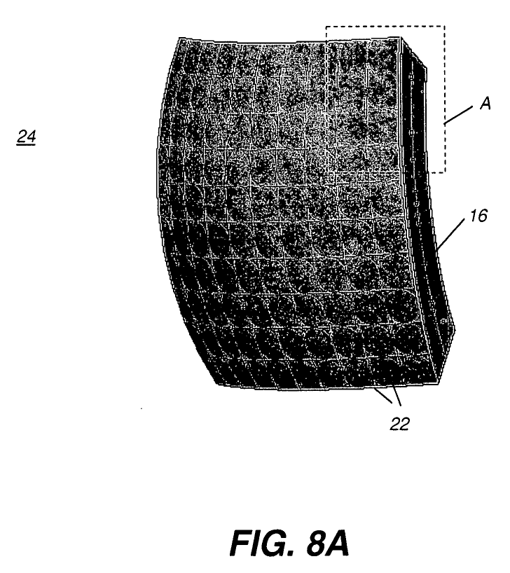

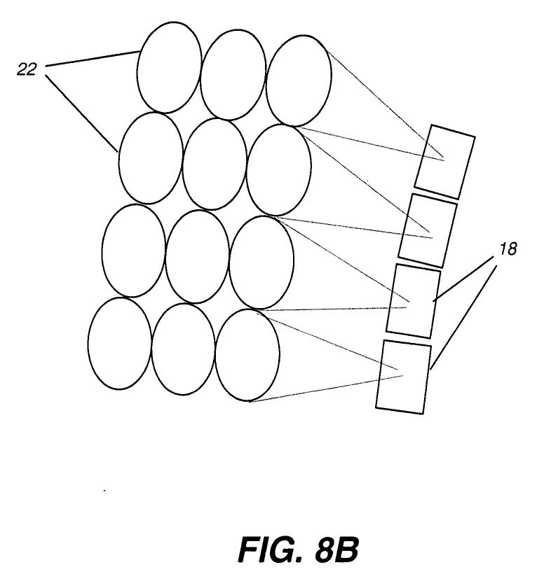

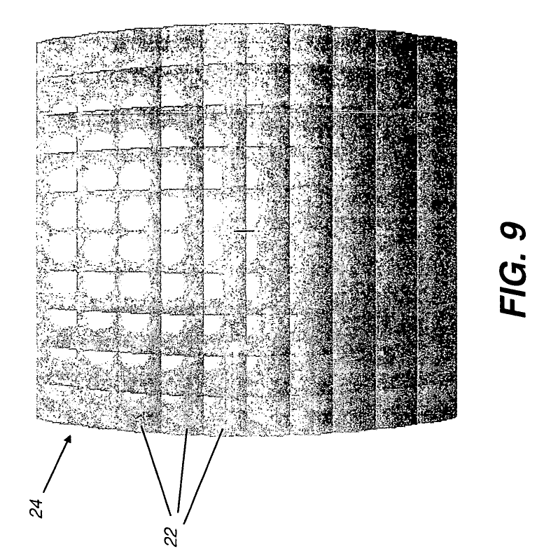

FIGS. 2 and 3 show functional components and representative light paths for a portion of curved lenslet array 24. FIG. 8A shows one embodiment, in which curved lenslet array 24 is a 10×10 array of lenses 22 with a 78% fill factor. A portion A of curved lenslet array 24 is shown enlarged in FIG. 8B. The space between each lens 22 and its corresponding sensor 18 may be air space or may be a transparent medium such as glass or acrylic, may include one or more baffles 48 as are shown in FIG. 3, and may include any number of different structures and components for suitably directing light to sensor 18. One problem for a lenslet array having a fill factor of less than 100% is the effect of stray light from the non-usable area. FIG. 9 shows another embodiment, in which curved lenslet array 24 has a 100% fill factor. In this embodiment, the overall light collection efficiency is higher, and the stray light is easy to control with baffles.

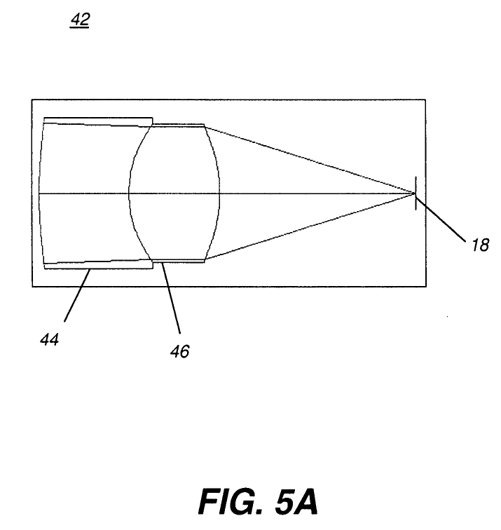

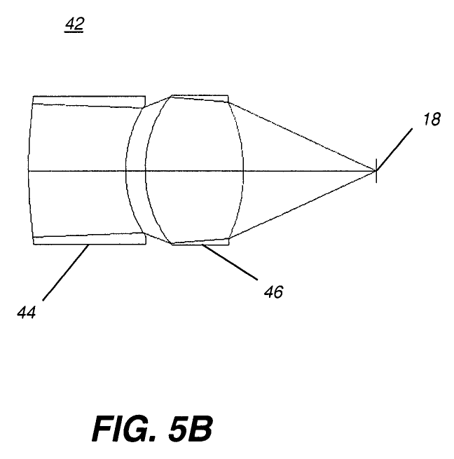

FIGS. 5A and 5B show refractive optical components of a doublet lens 42 that may form each lens 22 in lenslet array 24 of the present invention. The use of doublet lens 42 provides improved color correction. Doublet lens 42 consists of a first lens 44 and a second lens 46 that directs the light to sensor 18. Doublet lens 42 can be embodied as a cemented unit, with first and second lenses 44, 46 contiguous (FIG. 5A) or separated (FIG. 5B). For the single unit construction of FIG. 5A, first and second lenses 44, 46 may be part of a single lenslet sheet. For the embodiment of FIG. 5B, there may be separate sheets for each lens 44 or 46 shape, registered to each other. It must be noted that alignment of substrate sheets containing lenslets conforming to a convex curvature, and alignment of each doublet lens 42 to its corresponding sensor 18 may require a fixture.

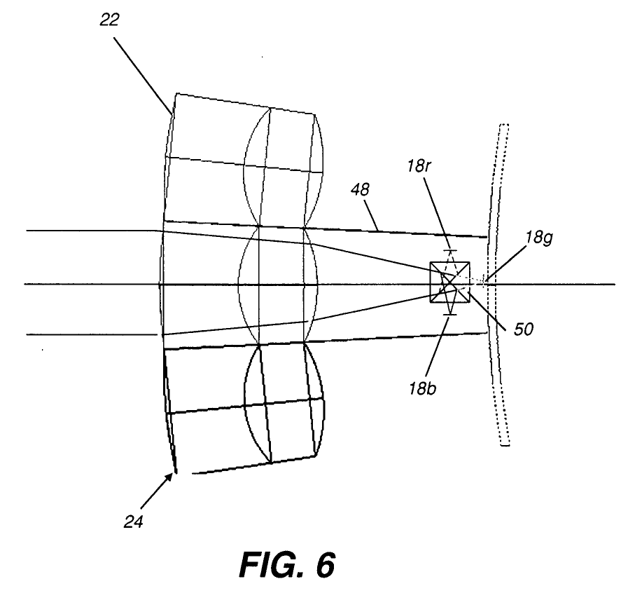

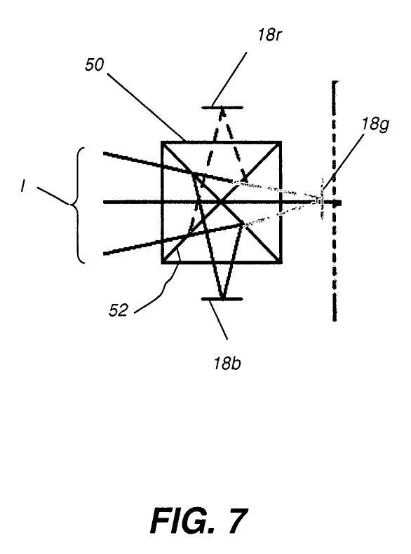

Detection of color can be accomplished in a number of different ways. Sensor 18, for example, may be sectioned for color sensing provided with color filters for detection of red, green, and blue (RGB) components. Alternately, the light directed from each lens 22 may be separated into its composite colors. Referring to FIGS. 6 and 7, there is shown an arrangement in which each lens 22 has a corresponding color separator 50 for separating the incident light into its separate RGB components and directing each component to a corresponding red, green, or blue sensor 18r, 18g, or 18b. In this arrangement, an array of color separators 50 is provided, having a convex curvature corresponding to the convex curvature of lenslet array 24. Array of color separators 50 may be formed onto a flexible substrate. Red, green, and blue sensors 18r, 18g, and 18b then detect the color content of the received light. In one embodiment, color separator 50 operates as an X-cube, familiar to those skilled in color separation techniques. As shown in FIG. 7, incident light 1 is separated at one or more dichroic surfaces 52 that selectively transmit or reflect light by wavelength.

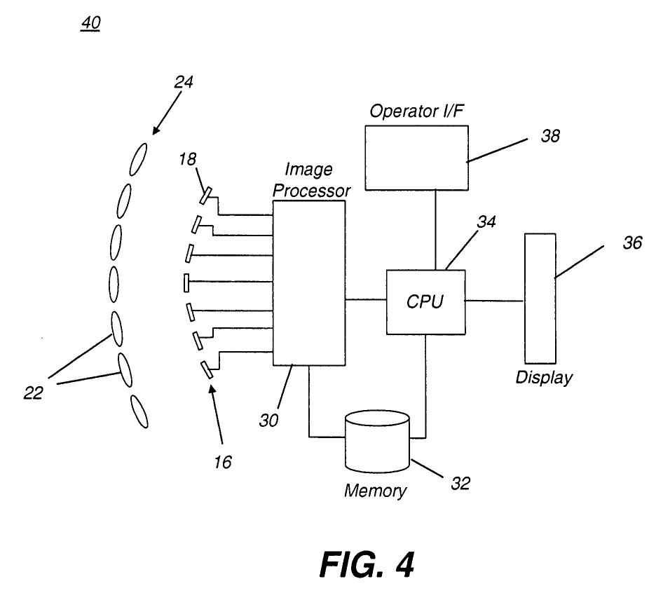

Referring to FIG. 4, there is shown, in block diagram form, a configuration of a camera 40 using curved lenslet array 24 and curved sensor array 16 of the present invention. Sensors 18 in curved sensor array 16 provide sensed image data to an image processor 30, which may store image data obtained in a memory 32 or other type of data buffer. A control logic processor 34 communicates with an operator interface 38, directs the operation of image processor 30, and typically displays the captured image on a display 36, such as an LCD or OLED display, for example.

The method of the present invention provides an imaging system that can be scaled to allow a larger number of lenslets to be used, thereby improving the light collection and field of view. The apparatus of the present invention takes advantage of a reduced focal length for providing a compact arrangement of components.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, the amount of curvature of curved lenslet array 24 may be varied from a spherical arrangement, depending on packaging requirements. The number of lenses 22 in lenslet array 24 can be adjusted, depending on the field of view that is needed. Lenslet array 24 components may be fabricated from any of a number of types of transparent materials, including plastics such as polystyrene and including glass. Sensors 18 may be any suitable type of light sensor and may be provided with appropriate filters for color sensing or for polarization.

The apparatus of the present invention is capable of providing improved imaging performance over image capture apparatus using conventional single-lens designs or flat panel lenslet arrays. Distortion is greatly reduced, color correction improved, and vignetting effects minimized. The present invention provides an apparatus that provides improved numerical aperture for gathering light over conventional flat panel lenslet cameras and can be adapted to high-resolution imaging requirements.

Thus, what is provided is an apparatus and method for providing improved wide-angle image capture over conventional designs using lenslets.

### Parts List

10 image capture apparatus
12 object
14 sensor array
16 sensor array
18 sensor
18r sensor, red
18g sensor, green
18b sensor, blue
20 lenslet array
22 lens
24 lenslet array
30 image processor
32 memory
34 control logic processor
36 display
38 operator interface
40 camera
42 doublet lens
44 first lens
46 second lens
48 baffle
50 color separator
52 dichroic surface

1. An imaging apparatus comprising:
(a) a sensor array comprising a plurality of optical sensors arranged in a convex curvature; and
(b) a lenslet array comprising a plurality of lenslets similarly arranged in a convex curvature, wherein at least one lenslet in the lenslet array directs light toward at least one optical sensor in the sensor array.

2. An imaging apparatus according to claim 1 wherein at least one sensor in the array of sensors is a charge-coupled device.

3. An imaging apparatus according to claim 1 wherein at least one sensor in the array of sensors is a CMOS device.

4. An imaging apparatus according to claim 1 wherein the convex curvature of the optical sensors is substantially spherical in shape.

5. An imaging apparatus according to claim 1 wherein a portion of the field of view of at least two adjacent lenslets overlaps.

6. An imaging apparatus according to claim 1 wherein the sensor array is formed on a flexible substrate.

7. An imaging apparatus according to claim 1 further comprising a color separator for separating light from at least one lenslet in the lenslet array into separate colors.

8. An imaging apparatus according to claim 1 wherein the sensor array comprises organic semiconductors.

9. An imaging apparatus comprising:
(a) a lenslet array comprising a plurality of lenslets arranged in a convex curvature; and
(b) a color separator array comprising a plurality of color separators, each color separator separating light from a corresponding lenslet into at least two separate color component beams according to light wavelength and directing each color component beam toward a corresponding optical sensor, obtaining a color image thereby.

10. An imaging apparatus according to claim 9 wherein the color separator array is formed on a flexible substrate.

11. An imaging apparatus according to claim 9 wherein the color separator comprises at least one dichroic surface.

12. An imaging apparatus according to claim 9 wherein the convex curvature of the lenslet array is substantially spherical in shape.

13. An imaging apparatus according to claim 9 wherein a portion of the field of view of at least two adjacent lenslets overlaps.

14. An imaging apparatus according to claim 9 wherein the optical sensor comprises an organic semiconductor.

15. An imaging apparatus according to claim 9 wherein the optical sensor is a charge-coupled device.

16. An imaging apparatus according to claim 9 wherein the optical sensor is a CMOS device.

17. An imaging apparatus comprising:
(a) a sensor array comprising a plurality of optical sensors arranged in a convex curvature;
(b) a lenslet array comprising a plurality of lenslets similarly arranged in a convex curvature, wherein at least one lenslet in the lenslet array directs light toward at least one optical sensor in the sensor array;
(c) an image processor for forming image data according to signals from the sensor array; and
(d) a memory for storing image data obtained from the image processor.

18. An imaging apparatus according to claim 17 wherein the sensor array is formed on a flexible substrate.

19. An imaging apparatus according to claim 17 wherein the at least one optical sensor comprises an organic semiconductor.

20. An imaging apparatus according to claim 17 wherein the at least one optical sensor is a CMOS device.

21. An imaging apparatus according to claim 17 wherein the at least one optical sensor is a charge-coupled device.

22. An imaging apparatus according to claim 17 wherein the convex curvature of the optical sensors is substantially spherical in shape.

23. An imaging apparatus according to claim 17 wherein a portion of the field of view of at least two adjacent lenslets overlaps.

24. A method for capturing an image, comprising
(a) forming a sensor array comprising a plurality of optical sensors arranged in a convex curvature; and
(b) disposing a lenslet array comprising a plurality of lenslets on a substrate having a convex curvature, such that light is directed from at least one lenslet in the lenslet array toward at least one optical sensor in the sensor array.

25. A method according to claim 24 wherein the step of forming a sensor array comprises the step of depositing an organic semiconductor on a flexible substrate.
